(19) United States
(12) Patent Application Publication
(10) Pub. No.: US 2024/0278851 A1
(43) Pub. Date: Aug. 22, 2024

(54) Unfinished Component for a Body of a Derivative Which is Derived from a Base Vehicle, and Method for Producing Said Unfinished Component

(71) Applicant: Bayerische Motoren Werke Aktiengesellschaft, Muenchen (DE)

(72) Inventors: Daniel HUBER, Muenchen (DE); Zeljko RAJIC, Kissing (DE)

(21) Appl. No.: 18/571,771

(22) PCT Filed: Jun. 1, 2022
(86) PCT No.: PCT/EP2022/064907

§ 371 Date: Dec. 19, 2023

(30) Foreign Application Priority Data
Jul. 1, 2021 (DE) 10 2021 116 979.8

(51) Int. Cl. B62D 25/08; C25D 13/12; F41H 7/02

(52) U.S. Cl. CPC B62D 25/088; C25D 13/12; F41H 7/02

(57) ABSTRACT

An unfinished component for a body of a derivative which is derived from a base vehicle, and more particularly, for a body of a civilian armored car. In order to provide such an unfinished component which is simple to produce and has a weight-saving design, the unfinished component is formed using a base unfinished component of the body of the derivative, more particularly, of the series production vehicle. The base unfinished component is reinforced in areas which are subject to high loads, and which are determined using a structural-mechanics simulation of the body of the civilian armored car, by means of local reinforcing elements, which are connected to the base unfinished component by way of joining.

### BACKGROUND AND SUMMARY

This disclosure relates to an unfinished component for a body of a derivative which is derived from a base vehicle, in particular of a special protection vehicle. The disclosure furthermore relates to a method for producing such an unfinished component.

In addition to base vehicles, an ever-increasing number of derivatives have come onto the vehicle market for several years in the field of automotive engineering. Such derivatives can involve, for example, other structural forms such as SUVs, cabriolets, sports-oriented vehicles, or also armor-plated special protection vehicles. Civilian special protection vehicles are currently normally produced on the basis of respective non-armor-plated base series-production vehicles by equipping these with corresponding armor-plating measures.

Since such vehicles. to a certain extent, have a significantly higher vehicle weight, or drives with significantly higher power, there may be significantly different requirements in terms of structural durability, precisely in the case of the loads. For example, armor-plating measures are known to be relatively heavy such that, for example, suspension strut domes or other unfinished components which come directly into contact with the chassis of the motor vehicle are under extremely high stress in terms of their structural durability, particularly in the case of dynamic load. In order to avoid in this case, for example, a failure of the respective unfinished components as a result of material fatigue or the like, such unfinished components such as, for example, suspension strut domes were, until now, newly produced specially for the special protection vehicle, in that they were produced from a material of a different type to the series-production unfinished component, and/or with a different material thickness. This nevertheless results in an extremely extensive additional outlay since, for example, tools for producing the suspension strut dome have to be entirely newly produced.

An object of the present disclosure is therefore to create an unfinished component for a derivative which is derived from a base vehicle as well as a method for the production thereof, wherein these enable easier production and a configuration of the respective unfinished component which is more expedient in terms of weight.

The unfinished component according to the disclosure for a body of a derivative which is derived from a base vehicle, for example, of a special protection vehicle, is formed according to the disclosure in that a series-production unfinished component, which can also be referred to as a base unfinished component, is used to create the unfinished component for the derivative/special protection vehicle, which series-production unfinished component is reinforced at points that are under high stress or excessive stress, determined on the basis of a structural-mechanical simulation of the body of the special protection vehicle, by local reinforcement elements which are connected to the series-production unfinished component by joining.

In contrast to the previous prior art, in the case of which such unfinished components for derivatives/special protection vehicles have been newly constructed, in comparison with the unfinished components of the base vehicle/series-production vehicle, for example, in terms of the material and/or the wall thickness, it is accordingly provided according to the disclosure, even in the case of the derivative/special protection vehicle, to use the base unfinished component/series-production unfinished component of the body of the base vehicle/series-production vehicle, and provide this in a targeted manner at those points with local reinforcement elements which have been determined as points under high stress in advance on the basis of a structural-mechanical simulation of the body of the derivative/special protection vehicle.

Such a structural-mechanical simulation can involve in particular a method with the aid of a finite element calculation, wherein other simulation methods are also conceivable. The body of the special protection vehicle provided with a higher weight, for example, as a result of its armor-plating, undergoes a corresponding simulation in particular in the regions which are relevant to structural durability, in order to initially detect on the basis of the series-production unfinished component where points under high stress occur, for example, and in particular in the case of a dynamic load. These points under high stress of the series-production unfinished component of the series-production vehicle which should now also be used as an unfinished component of the special protection vehicle, are provided according to the disclosure on the basis of the simulation carried out at the determined points under high stress with corresponding local reinforcement elements in order to be able to satisfy all the requirements in terms of structural durability, which are placed on the unfinished component of the special protection vehicle. As a result, the series-production unfinished component (base unfinished component) is thus reinforced and strengthened by local reinforcement elements in such a manner that this can also be used in the case of the body of the derivative/special protection vehicle with its increased input loads. As a result of the numerical simulation, the local weak points identified on the series-production component are thus subsequently strengthened with the local reinforcement components. As a result of this, the critical load path is mitigated and distributed over a large surface area via the modified series-production component. The unfinished component described in the present case or the associated method can be employed in all unfinished components of the special protection vehicle or another derivative which require strengthening measures in terms of structural durability as a result of the increased vehicle weight and/or as a result of other framework conditions such as, for example, increased vehicle drive power.

In an advantageous configuration of the disclosure, the series-production unfinished component is provided with a coating applied prior to the joining of the reinforcement elements, in particular, a cathodic dipping lacquer. The reinforcement elements can in this case be connected to the series-production unfinished component by a joining method, such as gluing, in order to form the unfinished component for the derivative/special protection vehicle. This results in particularly simple production of this modified unfinished component, which is low-cost.

The series-production unfinished component (base unfinished component) which serves as a base for the unfinished component of the derivative/special protection vehicle is formed in particular as a formed sheet-metal part or metal cast component. Other materials are naturally also conceivable. Such metal materials have in particular the advantage of correspondingly high structural durability and can be expediently connected to the local reinforcement elements.

The reinforcement elements are likewise formed either as formed sheet-metal parts or metal cast components, and are in this case, preferably matched to the material of the series-production unfinished component in order to avoid corrosion problems.

It has furthermore been shown to be advantageous if the respective local reinforcement element is formed at least substantially as a flat element. Such tab-like, flat, or curved elements are extremely easy to produce, and fasten to the series-production unfinished component in order to form the unfinished component of the derivative/special protection vehicle.

At corresponding corner regions, or in order to reinforce ribs or the like, it can furthermore be provided that the respective local reinforcement element is configured at least substantially as a three-dimensional structure. U-shaped configurations, corner reinforcements or the like can, for example, correspondingly be provided.

A further advantageous embodiment of the disclosure provides that the local reinforcement elements are also provided with a coating applied on the series-production unfinished component prior to joining, in particular, a cathodic dipping lacquer. As a result of this, in particular, a simple, but nevertheless highly effective coating of the entire unfinished component of the derivative/special protection vehicle is achieved.

### BRIEF DESCRIPTION OF THE DRAWINGS

FIG. 1 shows a perspective view onto an unfinished component of a body of a base vehicle/series-production vehicle, and a structural-mechanical simulation of the stresses in the case of use in the case of a body of a derivative derived from the base vehicle/series-production vehicle in the form of a special protection vehicle are determined, and as a result, points under high stress are apparent; and,

FIG. 2 shows a perspective view of the series-production unfinished component according to FIG. 1, reinforced at the points under high stress, determined on the basis of the structural-mechanical simulation of the series-production unfinished component, by local reinforcement elements, of which two reinforcement elements are furthermore emphasized in FIG. 2 in a cut-out and enlarged perspective view.

### DETAILED DESCRIPTION OF THE DRAWINGS

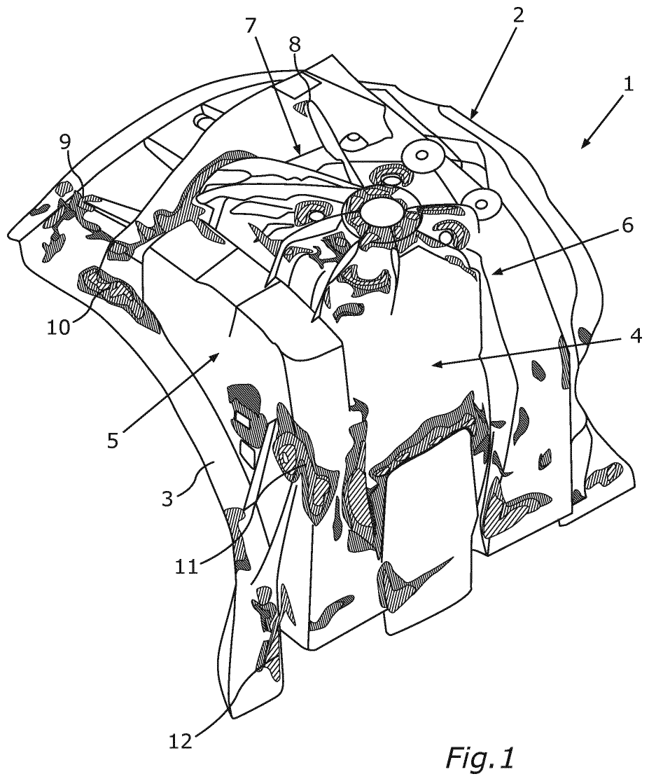

FIG. 1 shows in a perspective view a base unfinished component in the form of a series-production unfinished component 1 for a body of a non-armor-plated base vehicle/series-production vehicle, and in the form of a passenger vehicle. This base unfinished component/series-production unfinished component 1 is in the present case formed as a suspension strut dome component, or comprises such a suspension strut dome 2. This base unfinished component/series-production unfinished component 1, or the suspension strut dome 2, is fastened by way of respective flanges 3, for example, to a wheel arch unfinished component, not represented, which delimits a wheel arch for a respective vehicle wheel on the unfinished structure side. The suspension strut dome 2 is in the present case delimited at the top side by respective wall regions which are substantially on the outer circumferential side and by an end side 7.

It is thus provided in the present case that a derivative/special protection vehicle is produced on the basis of the non-armor-plated base vehicle/series-production vehicle which is then reinforced by armor-plating in a familiar manner. For example, this can involve a vehicle of the BMW 7 series in relation to which in the present case a special protection vehicle, which is also sometimes referred to as an armor-plated vehicle, with identical external dimensions is supposed to be produced. It is clear that unfinished components for bodies of other derivatives such as, for example, SUVs or vehicles having a particularly powerful drive can be created in an identical manner, instead of the present unfinished component here.

As a result of the fact that such special protection vehicles have a significant additional weight over the series-production vehicles, which is due in particular to armor-plating measures, such as reinforced vehicle panels, armor-plating measures in the region of the outer paneling parts or enlarged assemblies, for example, drive components, in particular unfinished components which are connected, for example, to chassis components of the special protection vehicle, are put under significantly more stress in terms of their structural rigidity than the respective series-production unfinished components 1.

In the context of the method according to the disclosure, a structural-mechanical simulation is accordingly performed and thus points under high stress of the series-production unfinished component 1 are determined, taking into account the additional weight and other dimensions or the like of the body of the special protection vehicle on the respective series-production unfinished component 1, in the present case therefore on the suspension strut dome part 2. FIG. 1 consequently shows, by way of example only, several of these points 8, 9, 10, 11, 12 under high stress, at which the series-production unfinished component 1 would be under excessive stress in the case of use in the case of the body of the special protection vehicle, and in terms of structural durability on the basis of the structural-mechanical simulation performed. The structural-mechanical simulation can involve in particular such a simulation based on a finite element calculation, wherein other simulations are also conceivable.

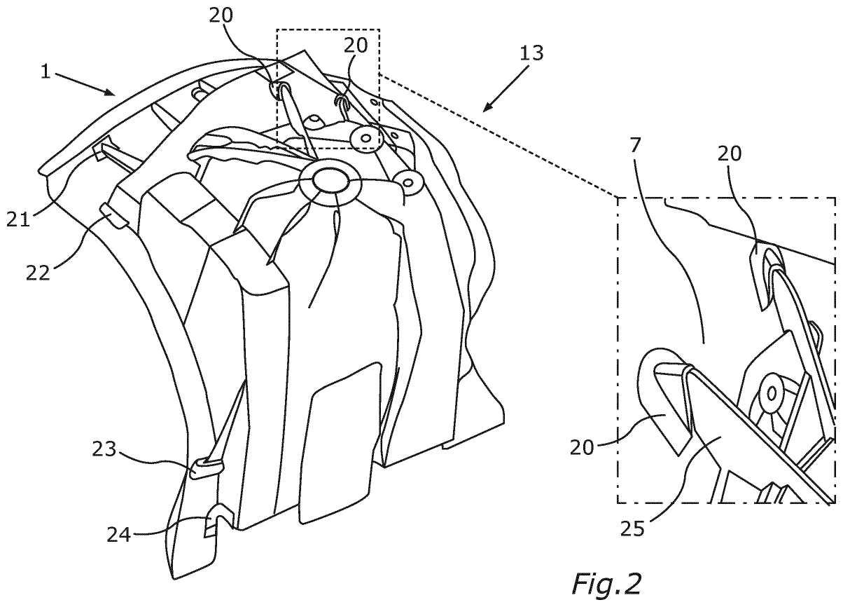

In order to thus obtain an unfinished component 19 which is suitable for the special protection vehicle or armor-plated vehicle, and is represented in FIG. 2 in a perspective view in an analogous manner to FIG. 1, and which withstands the elevated input loads, the series-production unfinished component 1 according to FIG. 1 has been reinforced and strengthened by respective reinforcement components 20, 21, 22, 23, 24 at the points 8 to 12, which are correspondingly under high stress or excessive stress, and determined by the numerical sensors. In contrast to the known prior art, in the case of which an entirely new unfinished component with a different material in comparison with the series-production unfinished component 1 and/or correspondingly larger material thicknesses has normally been used, it is thus provided that, in order to create the unfinished component 19 suitable for the special protection vehicle, a series-production unfinished component 1 is used which is provided and stiffened at the critical points 8 to 12 determined by the numerical simulation, by the respective reinforcement elements 20 to 24. As a result of this, the series-production unfinished component 1 can also be used in the case of the body for the special protection vehicle and, for example, no new tools have to be produced in order to create a different type of unfinished component. Development costs and additional material costs are furthermore naturally dispensed with.

The series-production unfinished component 1 is preferably provided with a coating, for example, a cathodic dipping lacquer, before the joining of the reinforcement elements 20 to 24. Another coating or lacquer or the like is also conceivable here. As a result, the series-production unfinished components 1 are consequently formed, in particular, as formed sheet-metal parts, or metal cast components, for example, from an aluminum pressure cast alloy.

The local reinforcement elements 20 to 24 are likewise formed, for example, as formed sheet-metal parts, or metal cast components and, for example, of substantially flat shape, as is apparent on the basis of the element 22, or of a substantially three-dimensional configuration, as is apparent, for example, on the basis of the reinforcement elements 20, 21, 23, 24. As is apparent in FIG. 2, in a cut-out view and enlarged perspective view, these can engage in a U-shape around respective ribs 25 for end-side reinforcement or, as in the case of the reinforcement element 24, be formed in an angled manner. The two reinforcement elements 21 and 23 also serve the purpose of U-shaped engagement around respective ribs 25.

In this case, the reinforcement elements 20 to 24 can also be provided with a corresponding coating such as a cathodic dipping lacquer, another type of lacquer, or the like, even before joining with the series-production unfinished component 1.

The reinforcement elements 20 to 24 are connected to the series-production unfinished component 1 by joining, in particular by gluing, and attached at those points 8 to 12 at which respective weak points of the series-production unfinished component 1 during use in the body of the armored vehicle have arisen in the numerical simulation performed in advance. The respective reinforcement elements 20 to 24 are highly individually adapted to the size and load of the respective points 8 to 12 under high stress or excessive stress in order, as a result of this, to create the unfinished component 19 which is suitable for the body of the special protection vehicle. The reinforcement elements 20 to 24 are characterized in particular in that these are arranged only at the locally determined points 8 to 12, and have extremely small dimensions so that, for example, entire wall regions 4, 5, 6 of the suspension strut dome 2 are not reinforced or doubled, but rather only punctually at the points under high stress determined by numerical simulation.

### LIST OF REFERENCE SIGNS

1 Series-production unfinished component
2 Suspension strut dome
3 Flanges
4 Wall regions
5 Wall regions
6 Wall regions
7 End side
8 Point
9 Point
10 Point
11 Point
12 Point
19 Unfinished component
20 Reinforcement element
21 Reinforcement element
22 Reinforcement element
23 Reinforcement element
24 Reinforcement element
25 Rib

1.-9. (canceled)

10. An unfinished component for a body of a derivative which is derived from a base vehicle, the unfinished component comprising:
a base unfinished component of the body of the base vehicle; and,
local reinforcement elements connected by joining to the base unfinished component at points subject to high stress, as determined on the basis of a structural-mechanical simulation of the body of the derivative.

11. The unfinished component according to claim 10,
wherein the base unfinished component comprises a coating applied prior to the joining of the reinforcement elements.

12. The unfinished component according to claim 10, wherein the base unfinished component comprises a coating of a cathodic dipping lacquer.

13. The unfinished component according to claim 10,
wherein the base unfinished component comprises a sheet-metal part or metal cast component.

14. The unfinished component according to claim 10,
wherein the local reinforcement elements comprise sheet-metal parts or metal cast components.

15. The unfinished component according to claim 10,
wherein at least one local reinforcement element comprises a substantially flat element.

16. The unfinished component according to claim 10,
wherein at least one local reinforcement element comprises a three-dimensional structure.

17. The unfinished component according to claim 10,
wherein the local reinforcement elements comprise a coating applied prior to the joining of the reinforcement elements.

18. The unfinished component according to claim 10, wherein the local reinforcement elements comprise a coating of a cathodic dipping lacquer.

19. The unfinished component according to claim 10,
wherein the unfinished component is a suspension strut dome component.

20. The unfinished component according to claim 10, wherein the derivative which is derived from the base vehicle is a special protection vehicle.

21. A method for producing an unfinished component for a body of a derivative which is derived from a base vehicle, the method comprising:
reinforcing a base unfinished component of the body of a series-production vehicle at points that are subject to high stress;
determining the points that are subject to high stress by performing a structural-mechanical simulation of the body of the derivative;
wherein the reinforcing comprises joining local reinforcement elements to the base unfinished component.

22. The method according to claim 21, further comprising:
applying a coating of a cathodic dipping lacquer to the base unfinished component prior to joining the local reinforcement elements to the base unfinished component.

23. The method according to claim 21, further comprising:
forming the base unfished component via sheet metal forming or metal casting.

24. The method according to claim 21, further comprising:
forming the local reinforcement elements via sheet metal forming or metal casting.

25. The method according to claim 24, wherein at least one local reinforcement element is formed as a substantially flat element.

26. The method according to claim 24, wherein at least one local reinforcement element is formed as a three-dimensional structure.

27. The method according to claim 21, further comprising:
applying a coating of a cathodic dipping lacquer to the reinforcement elements prior to joining the local reinforcement elements to the base unfinished component.

28. The method according to claim 21, further comprising:
forming the unfinished component as a suspension structure dome component.

29. The method according to claim 21, wherein the derivative which is derived from the base vehicle is a special protection vehicle.
